(19) United States
(12) Patent Application Publication
(10) Pub. No.: US 2008/0180518 A1
(43) Pub. Date: Jul. 31, 2008

(54) APPARATUS, SYSTEM AND METHOD FOR VIDEO COMMUNICATION

(75) Inventor: Toru Miyazaki, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/022,558

(22) Filed: Jan. 30, 2008

(30) Foreign Application Priority Data
Jan. 31, 2007 (JP) 2007-022367

(51) Int. Cl. H04N 7/14

(52) U.S. Cl. 348/14.01; 348/E07.077

(57) ABSTRACT

According to one embodiment, there is provide a video communication apparatus including a first communication unit which conducts communication of management information with an external device through a cable at a first communication speed, an encryption unit which encrypts a video signal, a second communication unit which transmits the video signal encrypted by the encryption unit to the external device through the cable at a second communication speed faster than the first communication speed, a detecting unit which observes a communication situation to detect an error signal from the external device through the first communication unit, and a control unit which reduces the second communication speed of the second communication unit when the detecting unit detects the error signal.

### CROSS-REFERENCE TO RELATED APPLICATIONS

This application is based upon and claims the benefit of priority from Japanese Patent Application No. 2007-022367, filed Jan. 31, 2007, the entire contents of which are incorporated herein by reference.

### BACKGROUND

1. Field

One embodiment of the present invention relates to a video communication apparatus which has a communication function of performing transmission and reception at a plurality of transfer speeds, a video communication system, and a video communication method.

2. Description of the Related Art

Recently digital instruments become widespread, and the digital instruments have communication functions and enable a coordination operation. However, such digital communication functions are not always stably operated, and there is a demand for continuing the communication by taking a proper measure against a communication error.

For example, Jpn. Pat. Appln. KOKAI Publication No. 9-9075 discloses a communication apparatus for encrypted image communication, in which it is determined whether or not it is operated in an encrypted mode, and when not, the transmission is performed in a normal mode.

Although Jpn. Pat. Appln. KOKAI Publication No. 9-9075 discloses a general encryption communication, Jpn. Pat. Appln. KOKAI Publication No. 9-9075 does not show an effective measure against error for the communication function intended for video signals having a plurality of communication speeds such as HDMI (High-Definition Multimedia Interface).

That is, an inferior cable exists in HDMI and sometimes connection error is generated. In HDMI 1.3 Deep Color, because a transmission speed approximately doubles as compared to the conventional one, there is a risk of increasing the connection error caused by the inferior cable. Most contents transmitted through HDMI are encrypted, and the encryption cannot be deciphered when a communication defect is generated in a TMDS line. As a result, a picture and sound cannot be reproduced at all. When repeated authentication is performed, the encryption is stopped or HDMI 1.3 Deep Color is stopped, and an automatic changeover is set such that the picture is reproduced at a low speed. When the changeover is performed, a user is notified of the changeover. Similarly, in the case of DP (display Port), communication quality can be monitored from error correction data of a high-speed line.

Thus, Jpn. Pat. Appln. KOKAI Publication No. 9-9075 does not show the effective measure against error for the communication function intended for the video signals having a plurality of communication speeds such as HDMI.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing exemplary configurations of a video transmitting apparatus and a video receiving apparatus according to an embodiment of the invention;

FIG. 2 is an explanatory view showing an HDMI terminal dealt with by a video communication system according to an embodiment of the invention;

FIG. 3 is an explanatory view showing a display port dealt with by the video communication system of the embodiment;

FIG. 4 is a flowchart showing an example of error processing performed between the video transmitting apparatus and the video receiving apparatus of the embodiment;

FIG. 5 is a flowchart showing an example of the error processing performed on the side of the video transmitting apparatus of the embodiment;

FIG. 6 is an explanatory view showing an example of the error message on the side of the video receiving apparatus of the embodiment;

FIG. 7 is an explanatory view showing an error message and a change in video and voice format on the side of the video receiving apparatus of the embodiment;

FIG. 8 is an explanatory view showing a screen concerning an error message and an inability of encrypted communication on the side of the video receiving apparatus of the embodiment;

FIG. 9 is an explanatory view showing a screen concerning a change in resolution on the side of the video receiving apparatus of the embodiment;

FIG. 10 is a block diagram showing an example of a configuration of a video receiving apparatus according to an embodiment of the invention;

FIG. 11 is a flowchart showing an example of the error processing performed on the side of the video receiving apparatus of the embodiment; and

FIG. 12 is a block diagram showing an exemplary configuration of a broadcast receiving apparatus in which a video communication system according to an embodiment of the invention is used.

### DETAILED DESCRIPTION

Various embodiments according to the invention will be described hereinafter with reference to the accompanying drawings. In general, according to one embodiment of the invention, there are provided a video communication apparatus which takes a measure against error for a communication function of performing transmission and reception of video signals at a plurality of transfer speeds, a video communication system, and a video communication method.

One embodiment for achieving the object is a video communication apparatus comprising:

a first communication unit (17) which conducts communication of management information with an external device (D2) through a cable (C1) at a first communication speed;

an encryption unit (14) which encrypts a video signal;

a second communication unit (16) which transmits the video signal encrypted by the encryption unit to the external device through the cable at a second communication speed faster than the first communication speed;

a detecting unit (11) which observes a communication situation to detect an error signal from the external device through the first communication unit; and

a control unit (22) which reduces the second communication speed of the second communication unit when the detecting unit detects the error signal.

Therefore, even if a failure occurs to temporarily generate the error in the communication cable such as HDMI, the communication is not interrupted but continued for example by lowering the communication speed.

### Embodiment

An embodiment of the invention will be described in detail with reference to the drawing.

Usually, when a communication error is generated in digital data communication typified by a computer, transmitting and receiving sides recognize the communication error, and re-transmission is performed to ensure communication quality. However, in the digital video communication typified by HDMI, even if an error is generated in part of video data, video service is not completely broken although a noise is generated on a screen, and the data is not re-transmitted. HDMI and DVI can be cited as typical representatives of digital video signal transmission, and new transmission methods such as Display Port are also proposed. Generally the new transmission method is standardized such that high-resolution video can be transferred. Therefore, high quality is required in not only a transmitter and a receiver but also a cable.

Although in HDMI the cable quality is arbitrary in a design stage, quality test of authentication is performed to avoid the trouble in use. However, actually all the cables cannot be tested. Additionally, with the progress of the high-resolution digital video and voice format, a plurality of data transfer speeds are defined, whereby the communication quality depends on the video and voice format (data transfer speed). For example, in the cable in which communication can be conducted with no trouble in 1080i, sometimes an error is generated in 1080p. The method of transferring the finer digital signal is defined in recently-standardized HDMI Ver.1.3 Deep Color. In HDMI Ver.1.3 Deep Color, although resolution is similar to that of the conventional HDMI 1.2a, the actual transfer speed is defined up to 3.4 Gbps which is substantially double of the conventional transfer speed for the fine video data transfer.

In the digital video communication typified by HDMI, the receiving side can read the video and voice format using a low-speed communication path different from a digital video signal path. The low-speed communication path is realized by the cable having communication quality specifications lower than that of the high-speed digital video communication. However, both the transmitting and receiving sides do not measure the inferior quality in the communication path. As a result, only the transmitter selects and transmits the high-quality data which is obtained through the low-speed communication path based on the video and voice format, and a user cannot properly recognize a transfer situation when screen anomaly is generated by the cable quality.

Examples of a video communication apparatus and a video communication method having a function of detecting communication path quality in the digital video communication typified by HDMI to be able to continue the good digital video and voice signal communication in the way matched with the detected communication path quality are disclosed in the following embodiment.

(Video Communication Apparatus)

A video communication apparatus according to an embodiment of the invention will be described in detail with reference to the drawings.

(Error Detection and Speed Change on Transmitting Apparatus Side)

(Configuration)

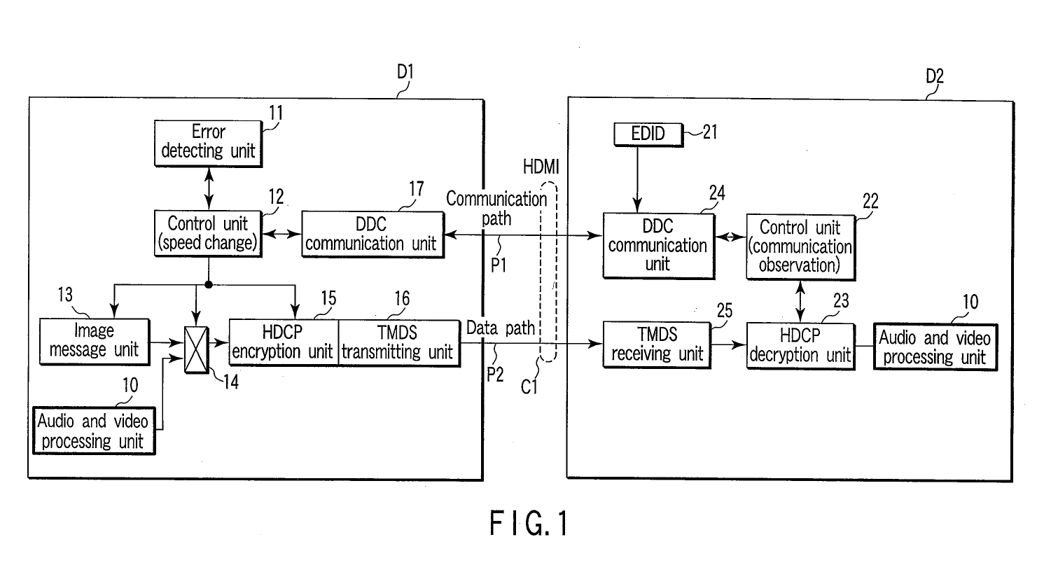

First, as shown in FIG. 1, communication processing performed by a video transmitting apparatus D1 and a video receiving apparatus D2 connected thereto by a HDMI cable C1 in the case where the transmitting apparatus side detects the error to make a determination on the speed change will be described. FIG. 1 is a block diagram showing configurations of a video transmitting apparatus and a video receiving apparatus according to an embodiment of the invention. The video communication apparatus of FIG. 1 is compatible with HDMI (the embodiment is not limited to HDMI, but the embodiment is compatible with Display Port or other digital communication standards).

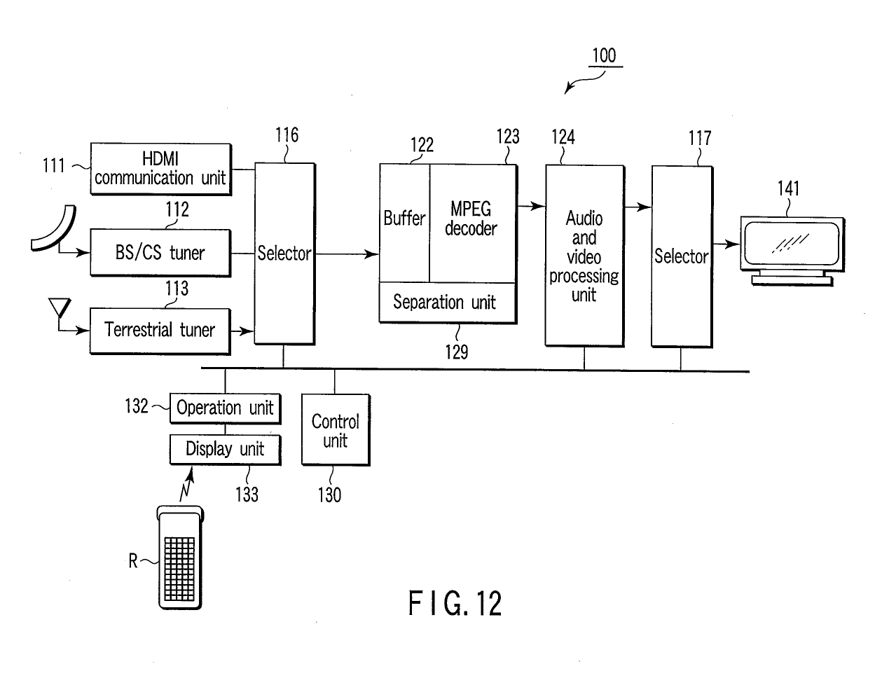

For example, the video transmitting apparatus D1 is a broadcast receiving apparatus 100 of FIG. 12 which displays a broadcast signal. The video transmitting apparatus D1 includes an audio and video processing unit 10, an error detecting unit 11, a control unit 12, an image message unit 13, and a superimposing unit 14. The audio and video processing unit 10 is a main part of the digital television. The error detecting unit 11 receives a signal indicating a communication situation from the video receiving apparatus D2, and the error detecting unit 11 detects the presence or absence of the communication error from the signal. The control unit 12 monitors various operation situations of the video transmitting apparatus D1 (source) to control the operations including the speed change. The image message unit 13 generates a text superimposed on the transmission video and an image message for the speed change. The superimposing unit 14 superimposes the image message and a video signal to be transmitted. The video transmitting apparatus D1 also includes an HDCP encryption unit 15, a TMDS transmitting unit 16, and a DDC communication unit 17. The HDCP encryption unit 15 prevents unauthorized copy of the video signal. The TMDS transmitting unit 16 converts the transmitted image data into an electric signal defined by HDMI and transmits the electric signal through a communication path P2. The DDC communication unit 17 conducts low-speed communication through a DDC line which is a communication path P1.

For example, the video receiving apparatus D2 is a digital television having the HDMI communication function. The video receiving apparatus D2 includes an EDID storage unit 21 and a DDC communication unit 24. EDID data for transmitting the video and voice format to the HDMI video transmitting apparatus D1 is stored in the EDID storage unit 21. The DDC communication unit 24 conducts the DDC line communication at a low speed through the DDC line which is the communication path P1. The video receiving apparatus D2 also includes a TMDS receiving unit 25, a control unit 22, an HDCP decryption unit 23, and the audio and video processing unit 10. The TMDS receiving unit 25 receives a TMDS signal defined by HDMI, and the TMDS receiving unit 25 converts the TMDS signal into a signal to which the subsequent data processing can be performed. The control unit 22 observes the communication situation of the video receiving apparatus D2 to supply a communication situation signal to the video transmitting apparatus D1 through the DDC communication unit 24, and the control unit 22 controls the entire operation. The HDCP decryption unit 23 decrypts an HDCP encrypted video signal supplied from the TMDS receiving unit 25. The audio and video processing unit 10 is a main part of the digital television shown in FIG. 12.

In the video transmitting apparatus D1 and video receiving apparatus D2 thus configured, the video receiving apparatus D2 supplies the signal indicating the communication situation to the video transmitting apparatus D1. The video transmitting apparatus D1 determines whether or not the communication error exists based on the signal indicating the communication situation, and the video transmitting apparatus D1 supplies a signal for an acceptance screen (FIG. 7) whether or not the communication speed is changed to the video receiving apparatus D2. When an acceptance signal (speed changing request signal) for accepting the speed change is received from the user through the video receiving apparatus D2, the HDMI communication speed is changed to continue the video signal communication, to avoid the communication interruption.

(HDMI Terminal and Display Port Terminal)

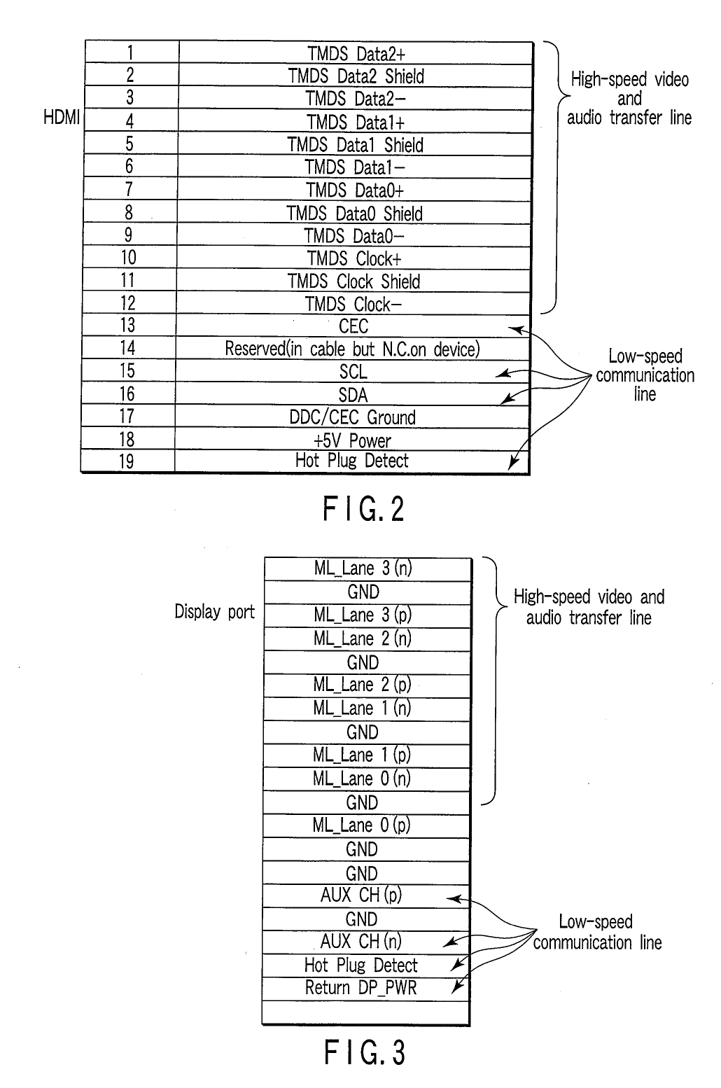

An HDMI terminal and a display port terminal will briefly be described with reference to FIGS. 2 and 3. FIG. 2 is an explanatory view showing the HDMI terminal dealt with by the video communication system of the embodiment, and FIG. 3 is an explanatory view showing the display port dealt with by the video communication system of the embodiment.

Referring to FIG. 2, in the HDMI terminal dealt with by the video communication system, a first terminal to a twelfth terminal correspond to the high-speed video and voice transmission line, a thirteenth terminal, a fifteenth terminal, a sixteenth terminal, a nineteenth terminal correspond to the low-speed communication line.

Referring to FIG. 3, a first-half 11 terminals of the display port correspond to the high-speed video and voice transmission line, and second-half four terminals correspond to the low-speed communication line.

(Operation)

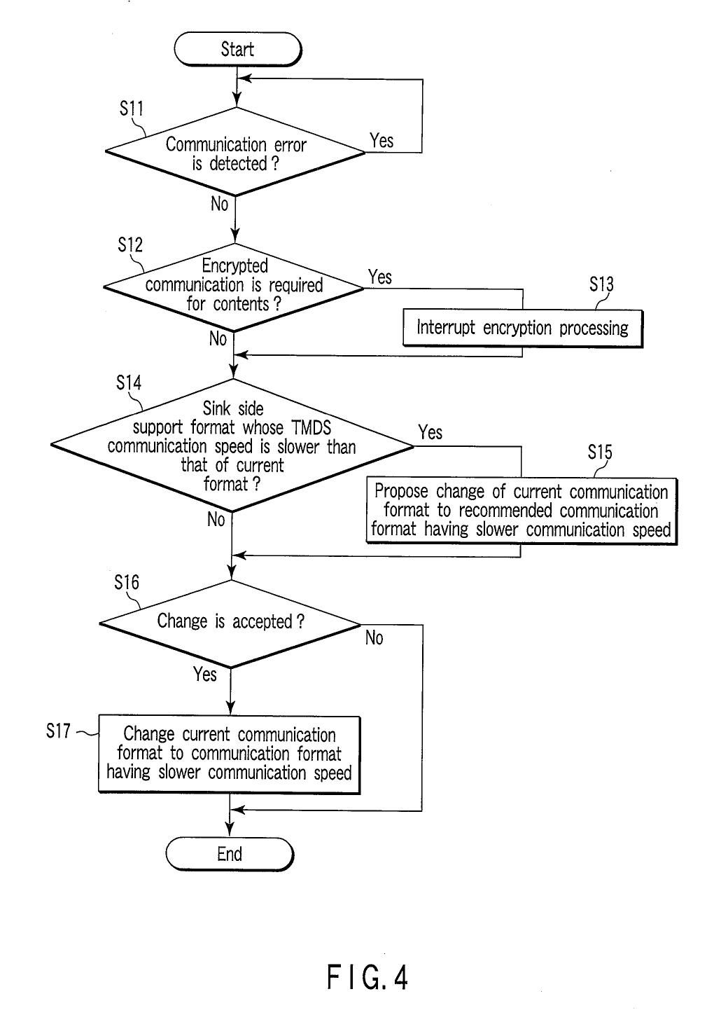

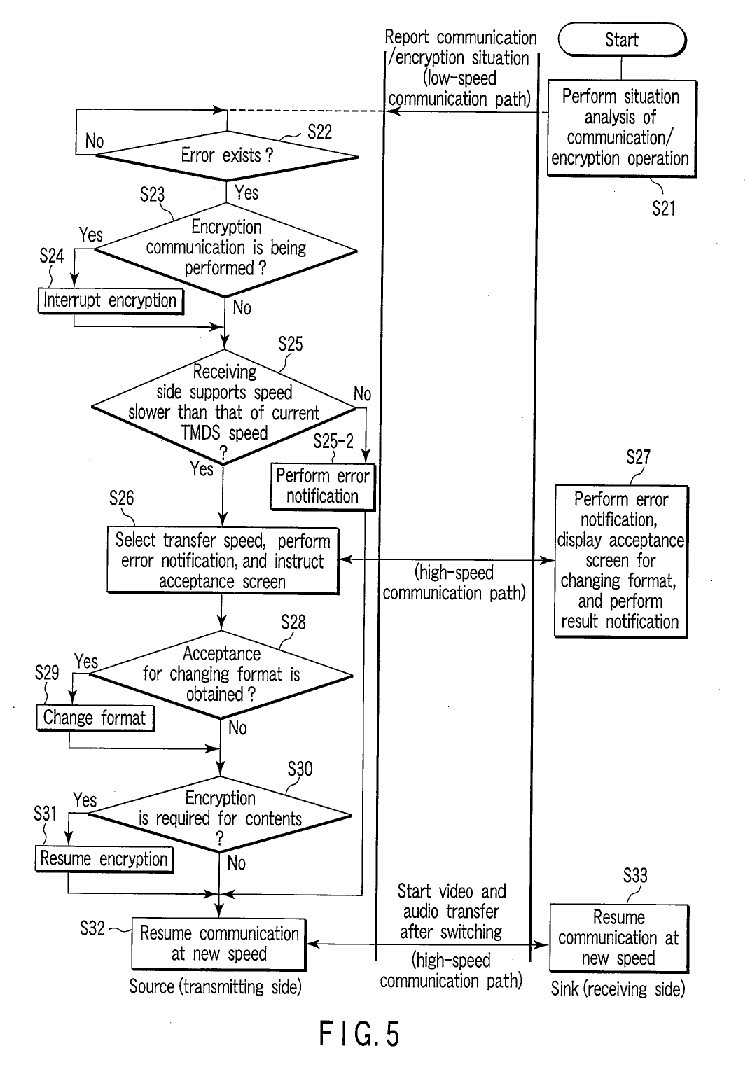

A communication operation performed by the video transmitting apparatus D1 and video receiving apparatus D2 will be described in detail with reference to flowcharts of FIGS. 4 and 5. FIGS. 4 and 5 are flowcharts showing an example of error processing performed between the video transmitting apparatus and the video receiving apparatus of the embodiment. Each step of the flowcharts shown in FIGS. 4 and 5 can be replaced by a circuit block. Accordingly, the steps of the flowcharts can be re-defined into the circuit block.

Which the video transmitting apparatus D1 or the video receiving apparatus D2 performs the processing is not particularly described in the flowchart of FIG. 4. In this case, the video communication system includes a plurality of pieces of video communication apparatus, and it is necessary that a certain step be performed by one of the pieces of video communication apparatus.

That is, in the flowchart of FIG. 4, for example, the error detecting unit 11 of the HDMI video transmitting apparatus D1 confirms the communication error (Step S11), the control unit 12 determines whether or not encryption processing is being performed to the video signal which is contents (Step S12). When the encryption processing is being performed to the video signal, the control unit 12 stops the encryption processing (Step S13). When the communication situation becomes an error state while the encryption processing is being performed, only re-authentication is repeated and nothing can be displayed on a screen of the receiving side.

Then, the control unit 12 confirms the video and voice formats which can be received by the HDMI video receiving apparatus D2, and the control unit 12 determines whether or not the confirmed video and voice formats support the video and voice format whose TMDS communication speed is slower than that of the current video and voice format (Step S14). When HDMI is used, the HDMI video transmitting apparatus D1 can read the receivable video and voice formats from the data of EDID 21 included in the HDMI video receiving apparatus D2. The control unit 12 selects the video and voice format in which a data speed in the high-speed communication path can be set to a low level from the receivable video and voice formats, and the control unit 12 display a message of “Communication error is observed. Video and voice format is changed to 480p?” on a screen of the receiving side as shown in FIG. 7 (Step S15).

The message of FIG. 7 can be displayed at the lowest transfer speed or by the video and voice format in which a minimum requirement is defined as a default on the receiving side in the communication standard, e.g., 480i or VGA in HDMI.

The new video and voice format is selected from the data of EDID 21 such that the image becomes the highest quality in a range where the data is thought to be transferable while the transfer speed is slower than that of the video and voice format to be originally displayed in the setting different from the setting in displaying the message of FIG. 7. After the message is displayed, when the acceptance is obtained from the user (Step S16), the transfer is started in the new video and voice format, and the encryption is restarted when the encryption is required for the contents (Step S17).

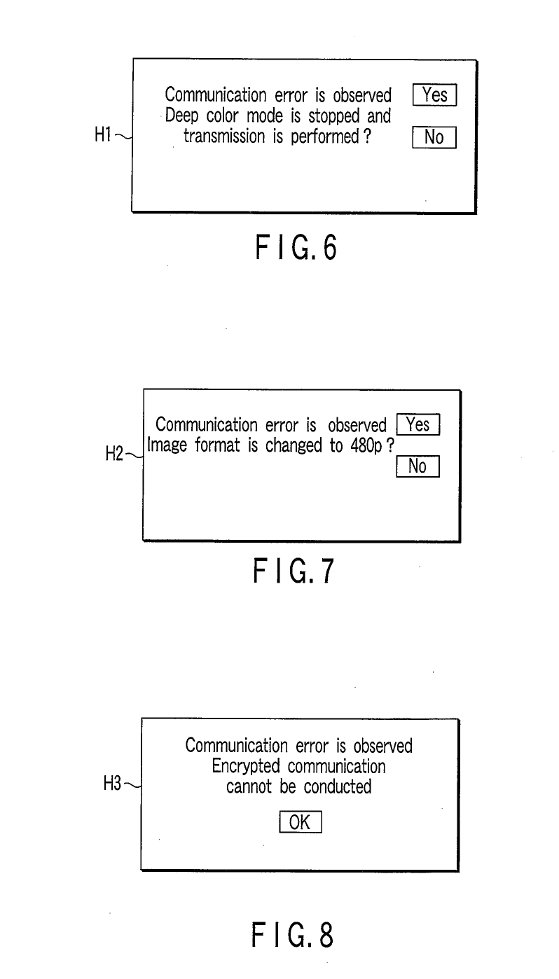

Examples of the message displayed for the user by the HDMI video receiving apparatus D2 will be described with reference to FIGS. 6 to 9. In HDMI Ver.1.3 Deep Color, the TMDS transfer speed is remarkably enhanced although the resolution is comparable to the conventional one. HDMI Ver.1.3 Deep Color has an ability of increasing a pixel quantization bit up to Y/Cb/Cr=4/4/4/16 bit at the maximum.

However, sometimes a 100% effect cannot be drawn depending on performance of the TV signal processing or display device on the receiving side. Sometimes deterioration of the image quality can be reduced when the quantization is decreased to the conventional 12/14/10/8 bit rather than the decrease in resolution. In such cases, to propose a method of interrupting HDMI Ver.1.3 Deep Color or changing the quantization to the small bit is effective as shown in the message of FIG. 6.

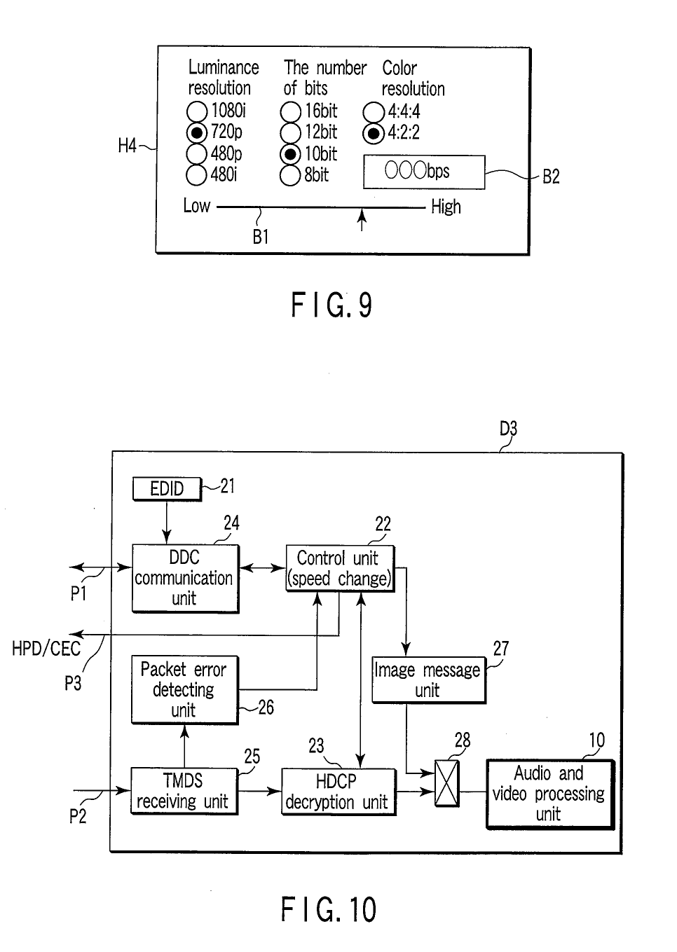

As shown in FIG. 9, preferably the user finally selects the resolution from a plurality of candidates. In FIG. 9, in the case of HDMI, the TMDS transfer speed is changed according to the luminance resolution and color resolution selected by the user and the number of bits. The user can confirm the transfer speed in the selected setting by a position of an arrow indicated in a bar counter B1. Preferably a communication speed B2 at that time is displayed on the screen of FIG. 9. Preferably a frequency format is changed.

In FIG. 9, preferably the position of the arrow indicated in the bar counter B1 with a pointer which the user can operate by the action of the control unit 12 and image message unit 13 of FIG. 1.

Thus, which the video transmitting apparatus D1 or the video receiving apparatus D2 performs the processing is described in the flowchart of FIG. 4. The steps are not always performed in one of the pieces of apparatus sides, and which the video transmitting apparatus D1 or the video receiving apparatus D2 performs the processing is not clearly described in the flowchart of FIG. 4. The invention can be implemented as long as the steps are performed by one of the pieces of apparatus in the system including the plurality of pieces of communication apparatus.

(Error Detection and Speed Change on Video Transmitting Apparatus D1 Side: Flowchart of FIG. 5)

The error detection and speed change performed on the side of the video transmitting apparatus D1 will be described in detail with reference to the flowchart of FIG. 5.

In the video receiving apparatus D2, for example, the control unit 22 observes the HDCP decryption unit 23 to perform situation analysis of communication/encryption operation (Step S21). A signal indicating the communication situation is supplied to the video transmitting apparatus D1 through the low-speed communication path P1.

Then, in the video transmitting apparatus D1, the error detecting unit 11 determines whether or no the error exists (Step S22). When the error detecting unit 11 detects the error, the control unit 12 determines whether or not the encryption communication is currently performed (Step S23). When the encryption communication is currently performed, the HDCP encryption unit 15 interrupts the encryption processing of the contents such as the video signal (Step S24).

In the video transmitting apparatus D1, for example, the control unit 12 determines whether or not the video receiving apparatus D2 supports the speed slower than the current TMDS speed (Step S25). When the control unit 12 determines that video receiving apparatus D2 does not support the speed slower than the current TMDS speed, the message that the communication error is observed is displayed as shown in FIG. 8 (Step S25-2). When the control unit 12 determines that video receiving apparatus D2 supports the speed slower than the current TMDS speed, the transfer speed selection, the error notification, and the acceptance screen instruction are performed to the video receiving apparatus D2 by the action of the control unit 12 and image message unit 13 (Step S26).

The video receiving apparatus D2 receives these signals to display the acceptance screen for changing the video and voice format as shown in FIG. 7. When an operation signal meaning the user's acceptance is obtained, the video receiving apparatus D2 displays a selection screen for the video and voice format (such as luminance resolution, the number of bits, and color resolution) as shown in FIG. 9. When the control unit 22 receives a selection signal from the user operation, the control unit 22 notifies the video transmitting apparatus D1 of the result (Step S27).

The video transmitting apparatus D1 determines whether or not the acceptance for changing the video and voice format is obtained according to the acceptance signal (speed changing request signal) and the selection signal (Step S28). When the acceptance is obtained, the video transmitting apparatus D1 changes the video and audio format according to the selection signal for the selection screen of the video and voice format (such as luminance resolution, the number of bits, and color resolution) (Step S29).

In the video transmitting apparatus D1, the control unit 12 determines whether or not the encryption is required for the video and voice signal of the currently transmitted contents (Step S30). When the encryption is required, the encryption processing is resumed (Step S31) and the video and audio transfer processing is resumed between the video transmitting apparatus D1 and the video receiving apparatus D2 at the new communication speed corresponding to the new video and voice format (Steps S32 and S33).

Thus, the error determination processing and the communication speed changing processing can be performed on the side of the video transmitting apparatus D1.

(Error Detection and Speed Change on Video Receiving Apparatus D3 Side)

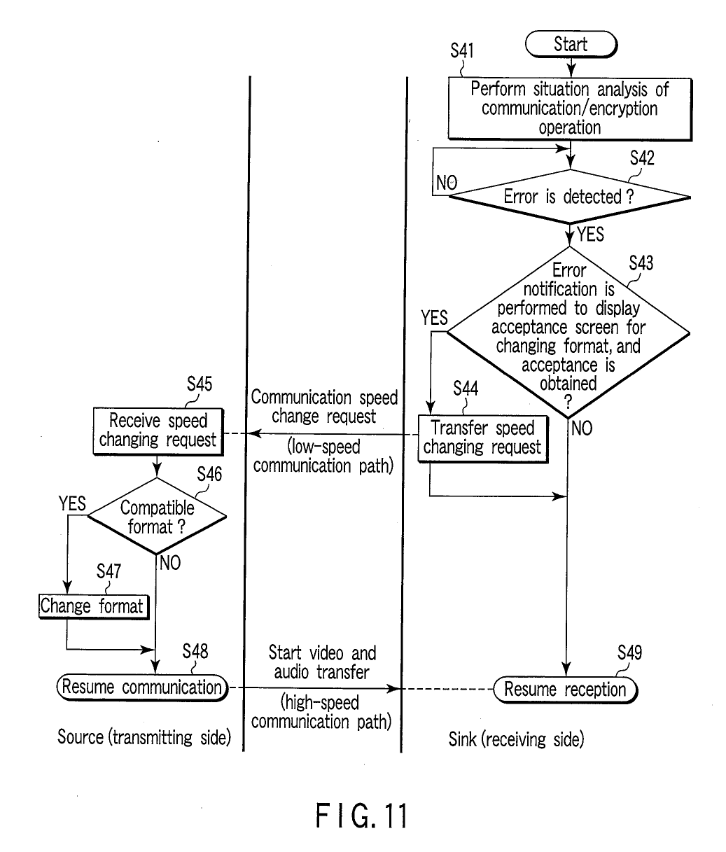

The configuration and communication processing in the case where the error detection and speed change are performed on the side of a video receiving apparatus D3 will be described with reference to FIGS. 10 and 11. FIG. 10 is a block diagram showing an example of a configuration of a video receiving apparatus D3 of the embodiment, and FIG. 11 is a flowchart showing an example of the error processing performed on the side of the video receiving apparatus D3 of the embodiment.

(Configuration)

FIG. 10 shows the configuration of the video receiving apparatus D3 when performing the error detection and speed change determination. As shown in FIG. 10, for example, the video receiving apparatus D3 is a digital television having an HDMI communication function. The video receiving apparatus D3 includes the EDID storage unit 21 and the DDC communication unit 24. The EDID data for transmitting the video and voice format to the HDMI video transmitting apparatus D1 is stored in the EDID storage unit 21. The DDC communication unit 24 conducts the DDC line communication at a low speed through the DDC line which is the communication path P1.

The video receiving apparatus D3 also includes the TMDS receiving unit 25, the control unit 22, the HDCP decryption unit 23, a packet error detecting unit 26, an image message unit 27, a superimposing unit 28, and the audio and video processing unit 10. The TMDS receiving unit 25 receives the TMDS signal defined by HDMI, and the TMDS receiving unit 25 converts the TMDS signal into the signal to which the subsequent data processing can be performed. The control unit 22 observes the communication situation of the video receiving apparatus D2 to supply the communication situation signal to the video transmitting apparatus D1 through the DDC communication unit 24, and the control unit 22 controls the entire operation. The HDCP decryption unit 23 decrypts the HDCP encrypted video signal supplied from the TMDS receiving unit 25, and the HDCP decryption unit 23 supplies the decryption error to the control unit 22 when detecting the decryption error. The packet error detecting unit 26 observes the TMDS receiving unit 25 to detect a packet error. The image message unit 27 generates image information on the acceptance screen for a communication error report and the video and voice format change. The superimposing unit 28 superimposes the image information and the decrypted video signal. The audio and video processing unit 10 is a main part of the digital television shown in FIG. 12.

(Operation)

The case in which the error detection and the communication speed change determination are performed on the side of the video receiving apparatus D3 having the configuration of FIG. 10 will be described with reference to FIG. 11. FIG. 11 is a flowchart showing an example of the error processing performed on the side of the video receiving apparatus D3 of the embodiment.

In the video receiving apparatus D3, the packet error detecting unit 26 continuously observes the TMDS receiving unit 25, and the packet error detecting unit 26 supplies the detection signal to the control unit 22 when the packet error detecting unit 26 detects the packet error. When the decryption error is detected from the HDCP decryption unit 23, the decryption error is supplied to control unit 22, performing the situation analysis of the communication/encryption operation (Step S41). As a result, when the control unit 22 detects the error signal (Step S42), the image message unit 27 displays the message screens of FIGS. 6 to 8. When the acceptance for the change is obtained (Step S43), the control unit 22 generates the speed changing request signal for changing the video and voice format to the video and voice format expressed by the operation signal for the message screen of FIG. 9, and the control unit 22 supplies the speed changing request signal to the video transmitting apparatus D1 through the communication path P1 (Step S44).

On the other hand, in the video transmitting apparatus D1, the control unit 12 receives the speed changing request signal (Step S45), and the control unit 12 determines whether or not the received speed changing request signal is the compatible video and voice format (Step S46). When the control unit 12 has determined that the speed changing request signal is the compatible video and voice format, the current video and voice format (luminance resolution, the number of bits, and color resolution) is changed to the new video and voice format (Step S47). Then, in the video transmitting apparatus D1, the video and audio transfer processing is resumed with the video receiving apparatus D2 at the new communication speed corresponding to the new video and voice format (Steps S48 and S49).

Similarly to the case sown in FIG. 1, the error detection and the speed change determination can be performed on the side of the video receiving apparatus D3. Preferably the video and voice format which is receivable by the receiver is changed on EDID 21 and the video transmitting apparatus D1 is informed using HPD.

Therefore, when the communication error is generated, the current video and voice format is changed to the optimum video and voice format by changing the transfer speed of the high-speed transmission line, so that the image can be transmitted in the optimum video and voice format.

(Broadcast Receiving Apparatus)

An example of a broadcast receiving apparatus to which the video communication system of the embodiment is applied will be described below with reference to FIG. 12. FIG. 12 is a block diagram showing a configuration of the broadcast receiving apparatus in which the video communication system of the embodiment is used.

In this case, the broadcast receiving apparatus is described as a digital television apparatus by way of example. However, the video communication apparatus of the embodiment includes various modes, and all the modes should be included in the scope of the invention.

In a broadcast receiving apparatus 100 of FIG. 12, the configurations except for the configuration of the audio and video processing unit 10 of the video communication apparatus D1 or D2 of the embodiment correspond to a communication unit 111. That is, the communication unit 111 has the communication function such as HDMI and the display port shown in FIGS. 1 and 2.

The broadcast receiving apparatus 100 of FIG. 12 mainly includes an MPEG decoder 123 which performs the broadcast reproduction processing and a control unit 130 which controls the operation of the apparatus main body. The broadcast receiving apparatus 100 also includes an input-side selector 116 and an output-side selector 117. The communication unit 111 such as LAN, HDMI, and the display port, a so-called satellite broadcast (BS/CS) tuner 112, and a so-called terrestrial tuner 113 are connected to the input-side selector 116, and the signal is output to the encoder 121. A satellite antenna is connected to the BS/CS tuner 112, and a terrestrial antenna is connected to the terrestrial tuner 113. In the broadcast receiving apparatus 100, a buffer 122, the MPEG decoder 123, and a separation unit 129 are connected to the control unit 130 through a data bus. The output of the selector 117 is connected to an external TV receiver 141 or supplied to an external device through an interface (not shown).

The broadcast receiving apparatus 100 also includes an operation unit 132 which is connected to the control unit 130 through the data bus to receive user's operation or operation of a remote controller R. In the remote controller R, the substantially same operation as the operation unit 132 provided in the main body of the broadcast receiving apparatus 100 can be performed. A tuner operation, a programmed recording setting, and various settings can be performed in the remote controller R.

Thus, the video communication apparatus of the embodiment can be applied to the communication unit of the broadcast receiving apparatus (such as digital television). According to the embodiment, even if the communication error is generated in HDMI due to the insufficient cable quality, the video is not completely interrupted, but the video signal can continuously be transmitted in the state in which the communication speed is lowered.

Those skilled in the art can implement the invention by the various embodiments described above, and it is further understood by those skilled in the art that various changes and modifications can easily be made without departing from the scope of the invention. Accordingly, the invention covers the broad range which is consistent with the disclosed principle and the novel feature, and the invention is not limited to the embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video communication apparatus comprising:
a first communication unit which conducts communication of management information with an external device through a cable at a first communication speed;
an encryption unit which encrypts a video signal;
a second communication unit which transmits the video signal encrypted by the encryption unit to the external device through the cable at a second communication speed faster than the first communication speed;
a detecting unit which observes a communication situation to detect an error signal from the external device through the first communication unit; and
a control unit which reduces the second communication speed of the second communication unit when the detecting unit detects the error signal.

2. A video communication system comprising:
a video transmitting apparatus; and
a video receiving apparatus connected to the video transmitting apparatus through a cable,
wherein the video transmitting apparatus includes:
a first communication unit which conducts communication of management information with the video receiving apparatus through the cable at a first communication speed;
an encryption unit which encrypts a video signal to output an encrypted video signal;
a second communication unit which transmits the encrypted video signal to the video receiving apparatus through the cable of the first communication unit at a second communication speed faster than the first communication speed; and
a first control unit which reduces the second communication speed of the second communication unit when the first communication unit receives a speed changing request signal from the video receiving apparatus, and
wherein the video receiving apparatus includes:
a third communication unit which conducts communication of the management information with the video transmitting apparatus through the cable at the first communication speed;
a fourth communication unit which receives the encrypted video signal from the video transmitting apparatus through the cable of the third communication unit at the second communication speed faster than the first communication speed;
a decryption unit which decrypts the encrypted video signal received by the fourth communication unit;
a detecting unit which detects an error signal from the video signal decrypted by the decryption unit; and
a second control unit which performs control to transmit the speed changing request signal to the video transmitting apparatus through the third communication unit when the detecting unit detects the error signal, the speed changing request signal requesting the video transmitting apparatus to reduce the second communication speed of the second communication unit.

3. The video communication system according to claim 2, further comprising:
a second detecting unit which detects a packet error of the encrypted video signal from the fourth communication unit or detects an error of the encrypted video signal decryption processing performed by the decryption unit, and supplies an error signal to the second control unit.

4. The video communication system according to claim 2, wherein the encryption unit interrupts encryption of the video signal when the first communication unit receives a communication error signal from the video receiving apparatus.

5. The video communication system according to claim 2, wherein the video receiving apparatus includes a generation unit which generates an acceptance screen when the detecting unit detects the error signal, an error and an acceptance for making a request that the second communication speed of the fourth communication unit is reduced being displayed on the acceptance screen, and
the second control unit transmits the speed changing request signal to the video transmitting apparatus through the third communication unit when receiving an acceptance signal corresponding to the acceptance screen.

6. The video communication system according to claim 2, wherein the cable connecting the video transmitting apparatus and the video receiving apparatus is an HDMI cable.

7. The video communication system according to claim 2, wherein the video receiving apparatus performs the speed change by changing resolution of the video signal or a frequency format.

8. The video communication system according to claim 2, wherein the video receiving apparatus performs the speed change by changing luminance resolution, the number of bits, and color resolution of the video signal or a frequency format in a range of a video and voice format which can be received by a receiver.

9. The video communication system according to claim 2, further comprising:
a display unit which displays a video picture on a screen according to the video signal decrypted by the decryption unit.

10. A video communication method performed between a video transmitting apparatus and a video receiving apparatus connected to the video transmitting apparatus through a cable,
in the video transmitting apparatus, the video communication method comprising:
conducting communication of management information with the video receiving apparatus through the cable at a first communication speed;
encrypts a video signal to output an encrypted video signal;
transmitting the encrypted video signal to the video receiving apparatus through the cable at a second communication speed faster than the first communication speed; and
reducing the second communication speed when a speed changing request signal is received from the video receiving apparatus,
in the video receiving apparatus, the video communication method comprising:
conducting communication of the management information with the video transmitting apparatus through the cable at the first communication speed;
receiving the encrypted video signal from the video transmitting apparatus through the cable at the second communication speed faster than the first communication speed;
decrypting the encrypted video;
detecting an error signal from the encrypted video signal; and
transmitting the speed changing request signal to the video transmitting apparatus when the error signal is detected, the speed changing request signal requesting the video transmitting apparatus to reduce the second communication speed of the second communication unit.
